(19) United States
(12) Patent Application Publication
(10) Pub. No.: US 2011/0100393 A1
(43) Pub. Date: May 5, 2011

(54) METHOD OF CLEANING MASK AND MASK CLEANING APPARATUS

(76) Inventors: Eri UEMURA, Kanagawa (JP); Makiko KATANO, Kanagawa (JP); Haruko AKUTSU, Kanagawa (JP); Shinji YAMAGUCHI, Tokyo (JP); Kyo OTSUBO, Tokyo (JP); Ayako MIZUNO, Kanagawa (JP)

(21) Appl. No.: 12/881,886

(22) Filed: Sep. 14, 2010

(30) Foreign Application Priority Data
Sep. 18, 2009 (JP) 2009-216422

(51) Int. Cl. B08B 7/00

(52) U.S. Cl. 134/1; 134/105

(57) ABSTRACT

The method of cleaning a mask of an embodiment includes irradiating a mask film having a mask pattern on a substrate with an energy radiation and heightening a temperature of the mask film than that of the substrate.

### CROSS-REFERENCE TO RELATED APPLICATIONS

This application is based upon and claims the benefit of priority from prior Japanese Patent Application No. 2009-216422, filed on Sep. 18, 2009, the entire contents of which are incorporated herein by reference.

### FIELD

Embodiments described herein relate generally to the method of cleaning mask and mask cleaning apparatus.

### BACKGROUND

As a method of cleaning a photomask in which a pellicle including a pellicle frame and a pellicle film bonded to an upper surface of the pellicle frame is mounted, a method of cleaning a photomask is known, that the photomask is irradiated with ultraviolet light so as to be heated and simultaneously ethylene glycol gas to which water vapor is added is introduced from a gas introduction hole formed in the pellicle frame, and a gas containing foreign substances is discharged from a gas exhaust hole formed in the pellicle frame.

However, in the method of cleaning a photomask, since water vapor is added, degree of humidity of the inside of the pellicle becomes high and a surface of the photomask is oxidized, so that dimensional variation of a pattern formed in the photomask becomes large. In addition, in the method of cleaning a photomask, since the whole of the photomask is heated, outgas is generate with accordance with increase in temperatures of an adherent agent interposed between the pellicle frame and the photomask and an adhesive agent interposed between the pellicle frame and the pellicle film, so that foreign substances having growth potential may adheres to the surface of the photomask.

### BRIEF DESCRIPTION OF THE DRAWINGS

FIG. 1 is a block diagram schematically showing a composition of a mask cleaning apparatus according to a first embodiment;

FIG. 2 is a cross-sectional view schematically showing the primary portion of a situation of cleaning treatment by the mask cleaning apparatus according to the first embodiment;

FIGS. 3A to 3C are cross-sectional views schematically showing the primary portions of steps of the cleaning treatment according to the first embodiment;

FIG. 4 is a graph showing a situation of an oxidization of a mask film at the irradiation of ultraviolet light in the first embodiment;

FIG. 5 is a table showing an organic compound total amount (an outgas generation amount) generated when the whole of the mask with pellicle is heated according to the first embodiment;

FIG. 6 is a table of ingredients of the outgas generated in the first embodiment;

FIG. 7 is a cross-sectional view schematically showing the primary portion of the mask cleaning apparatus according to a modification;

FIG. 8 is an explanatory view schematically showing a mask cleaning system according to a second embodiment;

FIG. 9 is an explanatory view schematically showing an exposure apparatus according to a third embodiment; and

FIGS. 10A to 10C are cross-sectional views schematically showing the primary portions of a method of manufacturing a semiconductor device according to the third embodiment.

### DETAILED DESCRIPTION

The method of cleaning a mask of an embodiment includes irradiating a mask film having a mask pattern on a substrate with an energy radiation and heightening a temperature of the mask film than that of the substrate.

### First Embodiment

### Composition of Mask Cleaning Apparatus

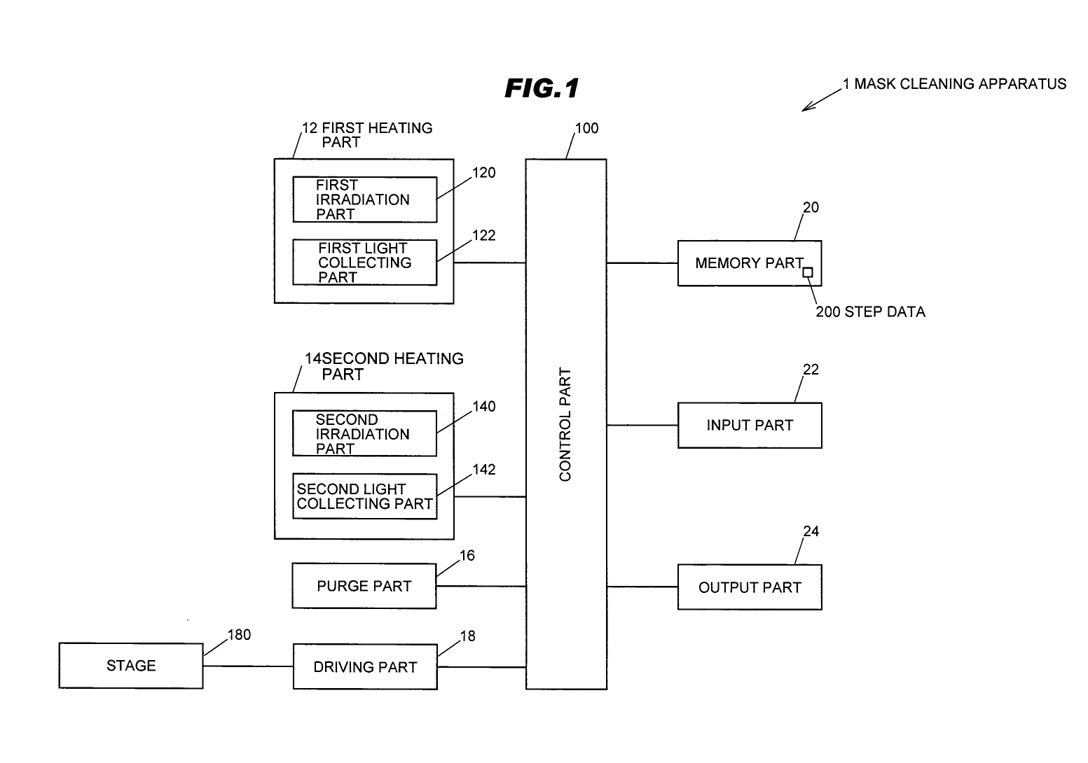

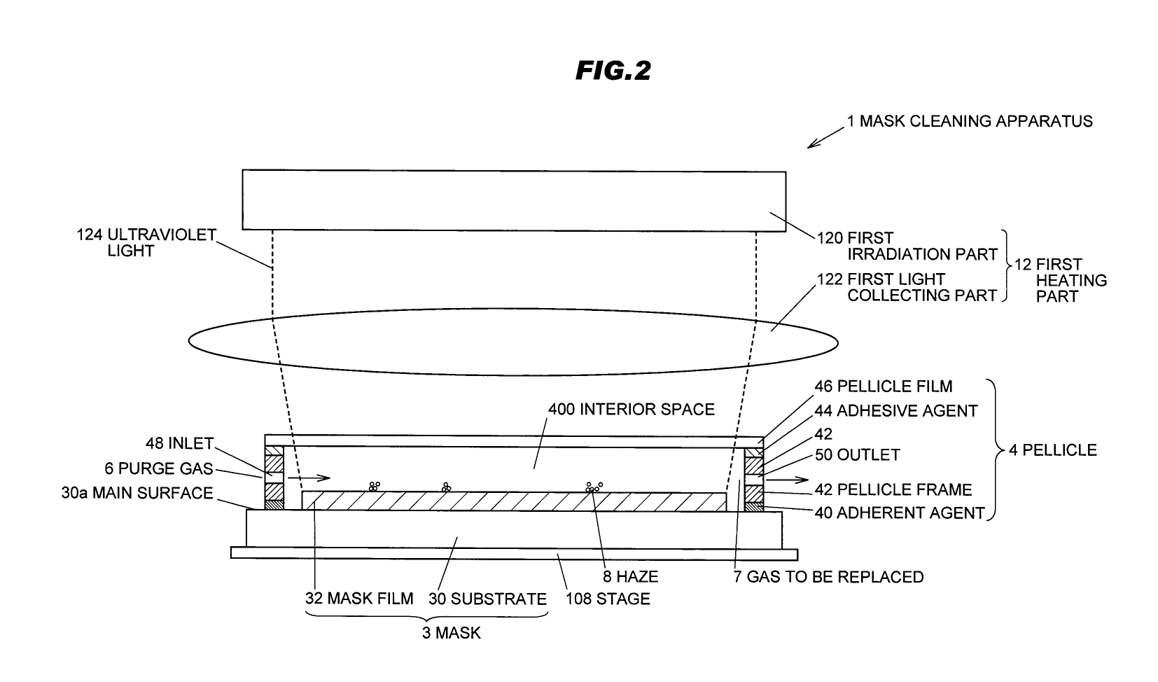

FIG. 1 is a block diagram schematically showing a composition of a mask cleaning apparatus according to a first embodiment. FIG. 2 is a cross-sectional view schematically showing the primary portion of a situation of cleaning treatment by the mask cleaning apparatus according to the first embodiment. The mask cleaning apparatus 1 is configured, for example, to carry out a cleaning of a mask 3 used for an exposure apparatus. As shown in FIG. 1, the mask cleaning apparatus 1 is roughly configured to include a first heating part 12, a second heating part 14, a purge part 16, a driving part 18, a memory part 20, an input part 22, an output part 24 and a control part 100. First, a composition of the mask 3 will be explained.

The mask 3 is, for example, a half tone mask of a multi gradation mask, and as shown in FIG. 2, includes a substrate 30 and a mask film 32 formed in a side of main surface 30a of the substrate 30. The mask film 32 is covered with a pellicle 4. Further, the mask 3 is not limited to the half tone mask, but a gray tone mask of a multi gradation mask, a binary mask of a two gradation mask configured to form a mask pattern with Cr or the like, a reflection type mask configured to be used for an extreme ultra violet (EUV) lithography method or the like can be also used.

The substrate 30 is, for example, a Si based substrate including Si as a main component.

The mask film 32 is, for example, a film including SiN as a main component. In the mask film 32, the mask pattern is formed.

The pellicle 4 is configured to prevent dust and the like from adhering to the mask film 32, and is roughly configured to include a pellicle frame 42 formed on the substrate 30 via an adherent agent 40 and a pellicle film 46 formed on the pellicle frame 42 via an adhesive agent 44.

As the adherent agent 40, for example, silicone or the like having properties that light resistance is high and an amount of gas generation is small is used.

The pellicle frame 42 is formed of, for example, an aluminum alloy, a synthetic resin, or the like. The pellicle frame 42 is configured, for example, to include at least one inlets 48 and at least one outlets 50 formed in the pellicle frame 42 opposite to the inlets 48. In the inlet 48 and the outlet 50, for example, a filter configured to prevent dust or the like is installed. It is preferable that the inlets 48 of not less than two and the outlets 50 of not less than two are formed in the pellicle frame 42 respectively.

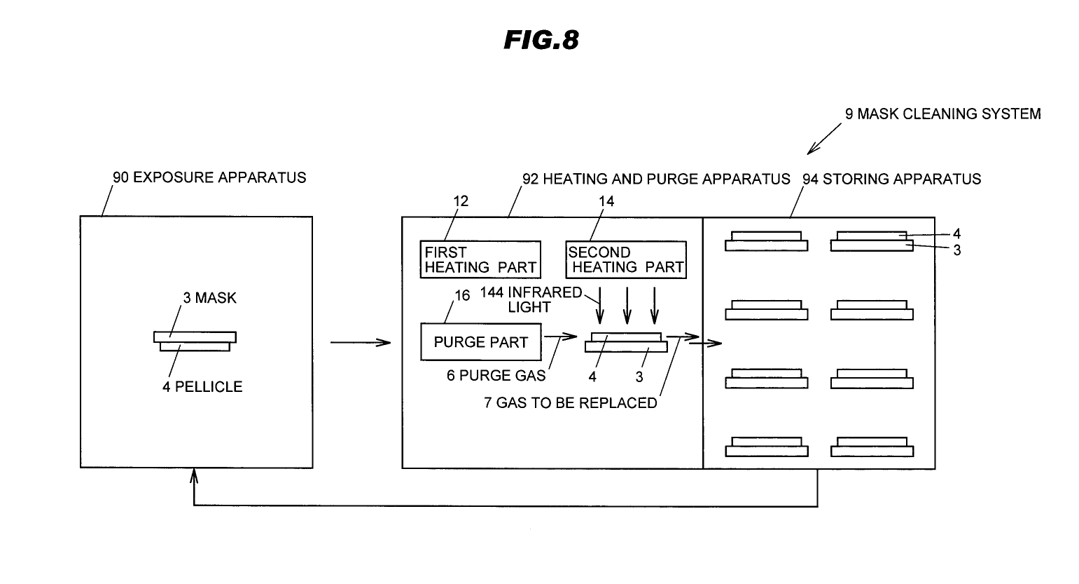

In addition, the inlets 48 and the outlets 50 are configured, for example, to have a composition that the inlets 48 and the outlets 50 are connected to a purge part 16 (refer to FIG. 8), a purge gas 6 sent out from the purge part 16 flows into an interior space 400 surround by the pellicle 4 and the substrate 30 from the inlets 48, and a gas to be replaced 7 in the interior space 400 is discharged from the outlets 50. The gas to be replaced 7 is, for example, an atmosphere in the interior space 400.

It is preferable that the pellicle film 46 has no absorption property of an exposure light and a high (not less than 99%) transmittance of the exposure light, and for example, a fluorine based organic compound or the like can be used.

As the adhesive agent 44, for example, an acrylic resin, a fluorine contained resin or the like that has a high adhesion strength can be used.

The first heating part 12 of the mask cleaning apparatus 1 is roughly configured to include a first irradiation part 120 and a first light collecting part 122.

The first irradiation part 120 is configured, for example, to irradiate the mask film 32 with ultraviolet light 124 as an energy radiation. The ultraviolet light 124 causes decomposition of foreign substances adhering to the mask film 32. Further, it is preferable that a temperature of the mask film 32 becomes higher than that of the substrate 30 due to the irradiation of the energy radiation in the first irradiation part 120, in addition, it is more preferable that a temperature of a surface of the mask film 32 becomes higher than that of an inside of the mask film 32. It is preferable that the ultraviolet light 124 has, for example, a wavelength of 100 to 300 nm, and more preferably, 150 to 200 nm. In the embodiment, for example, the ultraviolet light 124 having a wavelength of 193 nm is used, the wavelength of 193 nm being a wavelength of the exposure light when the exposure treatment is carried out by using the mask 3.

The first light collecting part 122 is configured, for example, to include a plurality of lenses and the like so as to collect the energy radiation irradiated from the first irradiation part 120 to the mask film 32.

The second heating part 14 is roughly configured, for example, to include a second irradiation part 140 and a second light collecting part 142.

The second irradiation part 140 is configured, for example, to irradiate the mask film 32 with an infrared light 144 as the energy radiation. The infrared light 144 causes the foreign substances separated from the mask film 32 to evaporate. Further, it is preferable that a temperature of the mask film 32 becomes higher than that of the substrate 30 due to the irradiation of the energy radiation in the second irradiation part 140, in addition, it is more preferable that a temperature of a surface of the mask film 32 becomes higher than that of an inside of the mask film 32. It is preferable that the infrared light 144 has, for example, a wavelength of 5 to 20 μm, and more preferably, 10 to 15 μm. In the embodiment, for example, the infrared light 144 having a wavelength of almost 12 μm is used, the wavelength of almost 12 μm being a absorption wavelength of SiN that is a main component of the mask film 32.

The second light collecting part 142 is configured, for example, to include a plurality of lenses and the like so as to collect the energy radiation irradiated from the second irradiation part 140 to the mask film 32.

The purge part 16 is configured, for example, to be connected to the inlets 48 and the outlets 50 of the pellicle 4. The purge part 16 is configured to send out the purge gas 6 from the inlets 48 into the interior space 400 of the pellicle 4.

The driving part 18 is configured, for example, to drive a stage 180 on which the mask 3 is mounted.

The memory part 20 is configured, for example, to include a hard disk drive (HDD) and the like so as to store the step data 200. The step data 200 are, for example, such that a wide variety of parameters relating to the cleaning treatment are included.

The input part 22 is configured, for example, to be connected to an input apparatus such as a key board.

The output part 24 is configured, for example, to be connected to an output apparatus such as a monitor.

The control part 100 is configured, for example, to include a central processing unit (CPU), a random access memory (RAM), a read only memory (ROM) and the like. The control part 100 is configured, as shown in FIG. 2, to control the first heating part 12, the second heating part 14, the purge part 16, the driving part 18, the memory part 20, the input part 22 and the output part 24. The control part 100 is configured to read out the step data 200 from the memory part 20 and to carry out the cleaning treatment based on the step data 200 read out. Hereinafter, the control part 100 is configured to readout the step data 200 and to control the first heating part 12 and the like based on the step data 200 read out, when the cleaning treatment is carried out.

Hereinafter, an action of the mask cleaning apparatus 1 according to the embodiment will be explained.

### (Action of Mask Cleaning Apparatus)

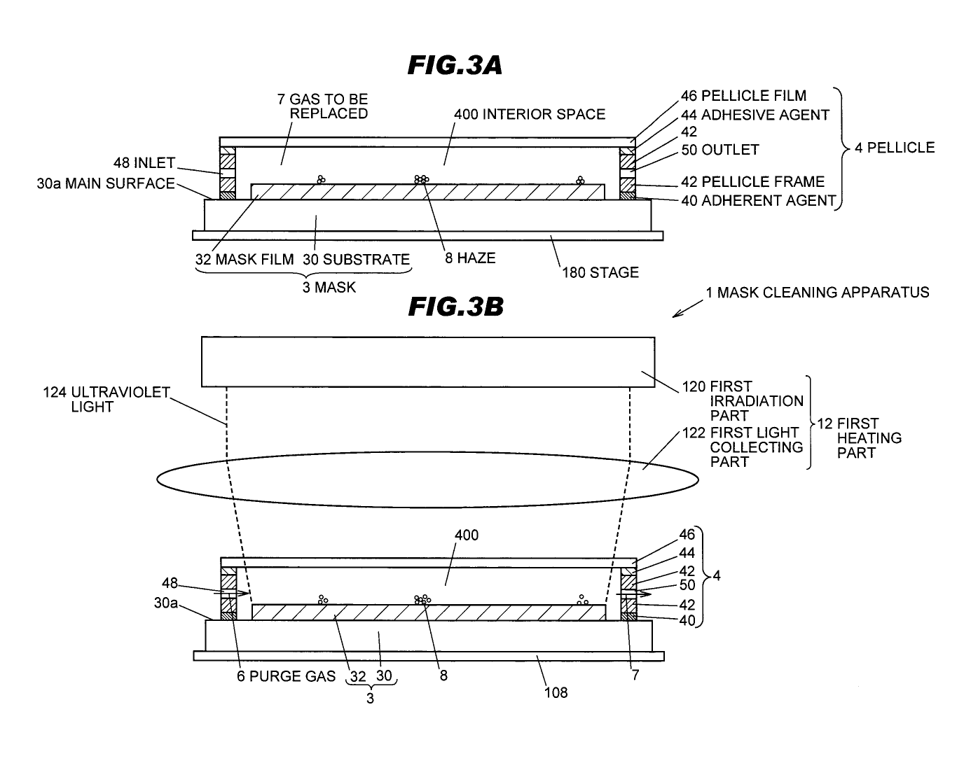

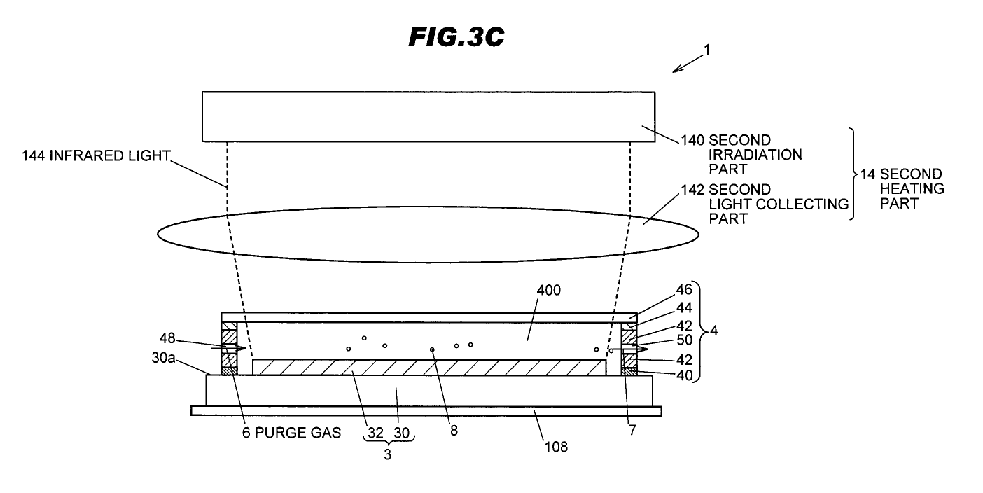

FIGS. 3A to 3C are cross-sectional views schematically showing the primary portions of steps of the cleaning treatment according to the first embodiment. A cleaning treatment that is repeatedly used for an exposure treatment and is configured to clean the mask 3 in which the haze 8 is grown on the mask film 32 will be explained. Here, the haze 8 is, for example, foreign substances having growth potential generated in the exposure steps, and includes trace substances obtained by adhering onto the mask film 32 from an environmental atmosphere of the exposure steps, and foreign substances obtained by that the outgas generated from the adherent agent 40, the adhesive agent 44 and the like constituting the pellicle 4 adheres onto the mask film 32, so as to be grown.

First, as shown FIG. 3A, the mask 3 with pellicle 4 in which the exposure steps are completed is mounted on the stage 180, and the stage 180 is moved under the first heating part 12 by the driving due to the driving part 18.

Next, as shown FIG. 3B, the whole of the mask film 32 is irradiated with the ultraviolet light 124 from the first irradiation part 120 via the first light collecting part 122. At this time, as the purge gas 6, an inert gas or air that does not have the same absorption wavelength as the irradiation wavelength and has a low degree of humidity is used. The purge gas 6 is sent out from the inlets 48 into the interior space 400 via the purge part 16. Due to the irradiation of the ultraviolet light 124, the haze 8 is decomposed, and the gas to be replaced 7 in the interior space 400 including the haze 8 separated from the mask film 32 is discharged from the outlets 50. Due to the irradiation of the ultraviolet light 124 and the purge gas 6, the surface of the mask film 32 is slightly oxidized, so that adhesion of the causative substances of the haze 8 to the mask film 32 can be prevented. Hereinafter, the reason why it is preferable that the purge gas 6 has a low degree of humidity will be explained.

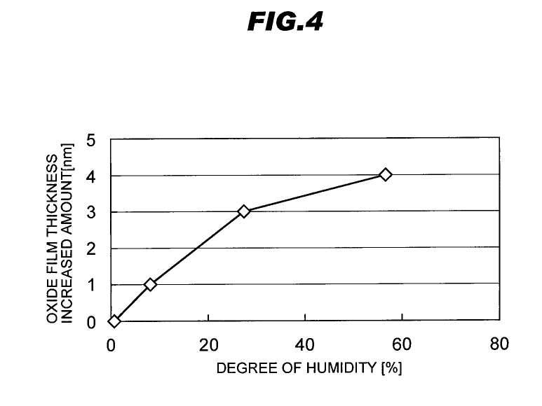

FIG. 4 is a graph showing a situation of an oxidization of a mask film at the irradiation of ultraviolet light in the first embodiment. In FIG. 4, the vertical axis shows an oxide film thickness increased amount (nm) that represents dimensional variation of the mask film 32 due to the irradiation of the ultraviolet light 124 and the horizontal axis shows a degree of humidity of the interior space 400. The measurement condition is such that the degree of humidity of the interior space 400 of the mask 3 with the pellicle 4 is varied, and dimensional variation after the degree of humidity is varied is measured. As a result of the measurement, as shown FIG. 4, the higher the degree of humidity becomes, the larger the dimensional variation of the mask film 32 due to the oxidation becomes. As described above, from the viewpoint of preventing the causative substances of the haze 8 from adhering to the mask film 32, it is more preferable that the degree of humidity is not more than 10% so as to reduce the oxide film thickness increased amount to not more than 1 nm as shown in FIG. 4.

Next, as shown in FIG. 3C, the stage 180 is moved under the second heating part 14 due to the driving by the driving part 18, and the whole of the mask film 32 is irradiated with the infrared light 144 from the second irradiation part 140 via the second light collecting part 142. At this time, as the purge gas 6, a clean dry air (CDA) or nitrogen is used.

The haze 8 decomposed due to the previous irradiation of the ultraviolet light 124 is evaporated by being further irradiated with the infrared light 144. Due to the irradiation of the infrared light 144, the mask film 32 is heated, for example, to about 150 degrees C. that is a heat resistance temperature of the mask film 32. Hereinafter, the reason why the mask film 32 is heated will be explained.

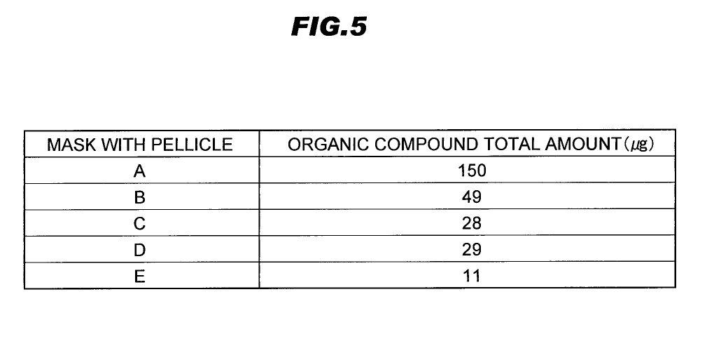

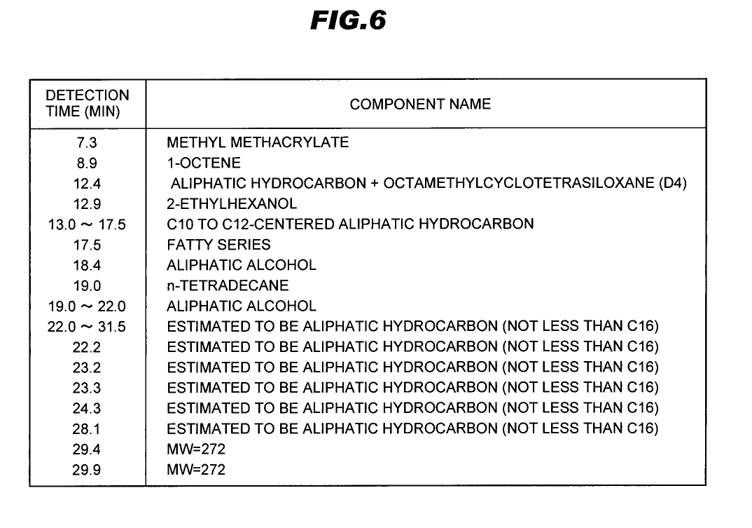

FIG. 5 is a table showing an organic compound total amount (an outgas generation amount) generated when the whole of the mask with pellicle is heated according to the first embodiment. FIG. 6 is a table of ingredients of the outgas generated in the first embodiment. The measurement is carried out by preparing masks with pellicle A to E, and heating each of the masks at 60 degrees C. for 5 hours.

As a result of the above-mentioned measurement, as shown in FIG. 5, it has been found that when the whole of the mask with pellicle is heated at 60 degrees C. for 5 hours, an outgas of 11 to 150 μg is generated. Due to the adhesion of the outgas onto the mask, there is a possibility that the outgas becomes the causative substances of the haze. In addition, since a heat resistance temperature of the pellicle 4 including the adherent agent and the adhesive agent is 60 to 70 degrees C. and a heat resistance temperature of the half tone film as the mask film is 150 degrees C., in case of only the mask film, it can be heated up to about 150 degrees C., but in case of the whole of the mask with pellicle 4, it can only be heated up to 70 degrees C. In addition, as shown in FIG. 5 and FIG. 6, due to the heating of 70 degrees C., an outgas that has a high possibility that it becomes the causative substances of the haze is generated. Consequently, in the mask cleaning apparatus 1 according to the embodiment, the mask film 32 is heated by the second heating part 14 so as not to elevate the temperatures of the adherent agent 40 and the adhesive agent 44 that have a low heating resistance temperature, so that the haze 8 on the mask film 32 can be effectively evaporated without generation of the outgas and the gas to be replaced 7 including the haze 8 evaporated can be discharged from the outlets 50.

Next, after the gas to be replaced 7 in the interior space 400 is discharged, for example, the mask 3 is housed in a storing cabinet and the treatment is completed.

Hereinafter, a modification will be explained.

### (Modification)

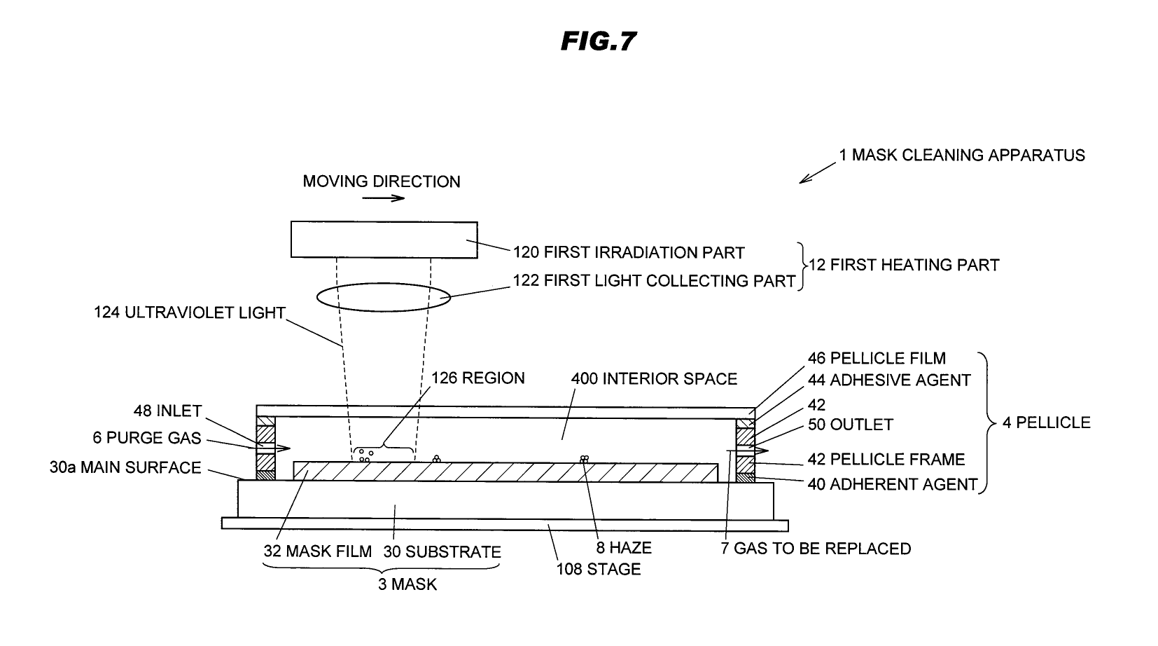

FIG. 7 is a cross-sectional view schematically showing the primary portion of the mask cleaning apparatus according to a modification. The modification is different from the first embodiment in an irradiation method of the ultraviolet light 124 and the infrared light 144 to the mask film 32.

In the mask cleaning apparatus 1 according to the first embodiment, the whole of the mask film 32 is heated at a time, but not limited to this, the first and second heating parts 12, 14 can be configured to scan a region 126 as an irradiation range like the modification. Further, as described above, a composition that the scan is carried out by that the first and second heating parts 12, 14 are moved can be adopted, a composition that the scan is carried out by that the stage 180 is moved can be also adopted, and further a composition that the scan is carried out by that the first and second heating parts 12, 14 and the stage 180 are relatively moved can be also adopted.

### Second Embodiment

The second embodiment shows a mask cleaning system using the cleaning method according to the first embodiment. Hereinafter, to the same elements in compositions and functions as those of the first embodiment, the same references as used in the first embodiment will be used, and detail explanation will be omitted.

FIG. 8 is an explanatory view schematically showing a mask cleaning system according to a second embodiment. As shown in FIG. 8, the mask cleaning system 9 is roughly configured to include an exposure apparatus 90, a heating and purge apparatus 92 and a storing apparatus 94.

The exposure apparatus 90 carries out an exposure treatment by using the mask 3 with pellicle 4.

The heating and purge apparatus 92 is configured to carry out the cleaning treatment, and is roughly configured, for example, to mainly include the first and second heating parts 12, 14 and the purge part 16 that have the same composition as the first embodiment. As the irradiation of the energy radiation, both of the irradiation to the whole of the mask film 32 and the irradiation with scanning can be adopted.

The storing apparatus 94 is configured, for example, to store the mask 3 with pellicle 4 in which the cleaning treatment is completed. The storing apparatus 94 is configured, for example, to be adjacent to the heating and purge apparatus 92 and to have a composition that the mask 3 with pellicle 4 does not come into contact with external air.

Hereinafter, an action of the mask cleaning apparatus 1 according to the second embodiment will be explained.

### (Action of Second Embodiment)

First, the mask 3 with pellicle 4 that is used in a predetermined frequency is moved to the heating and purge apparatus 92 by the exposure apparatus 90.

Next, the mask film 32 of the mask 3 with pellicle 4 moved to the heating and purge apparatus 92 is irradiated with the ultraviolet light 124 from the first heating part 12 and simultaneously the purge gas 6 is sent out from the purge part 16 into the interior space 400 via the inlets 48 of the pellicle 4. As the purge gas 6, air including oxygen having a low degree of humidity is used. The ultraviolet light 124 has the same wavelength as the ultraviolet light used in the first embodiment.

Next, the mask film 32 of the mask 3 with pellicle 4 is irradiated with the infrared light 144 from the second heating part 14 and simultaneously the purge gas 6 is sent out from the purge part 16 into the interior space 400 via the inlets 48 of the pellicle 4. As the purge gas 6, CDA or nitrogen is used. The infrared light 144 has the same wavelength as the infrared light used in the first embodiment.

Next, after atmosphere in the interior space 400 is entirely replaced with the purge gas 6, the mask 3 with pellicle 4 is moved to the storing apparatus 94 and the cleaning treatment is completed.

### Third Embodiment

The third embodiment shows an exposure apparatus using the cleaning method according to the first embodiment.

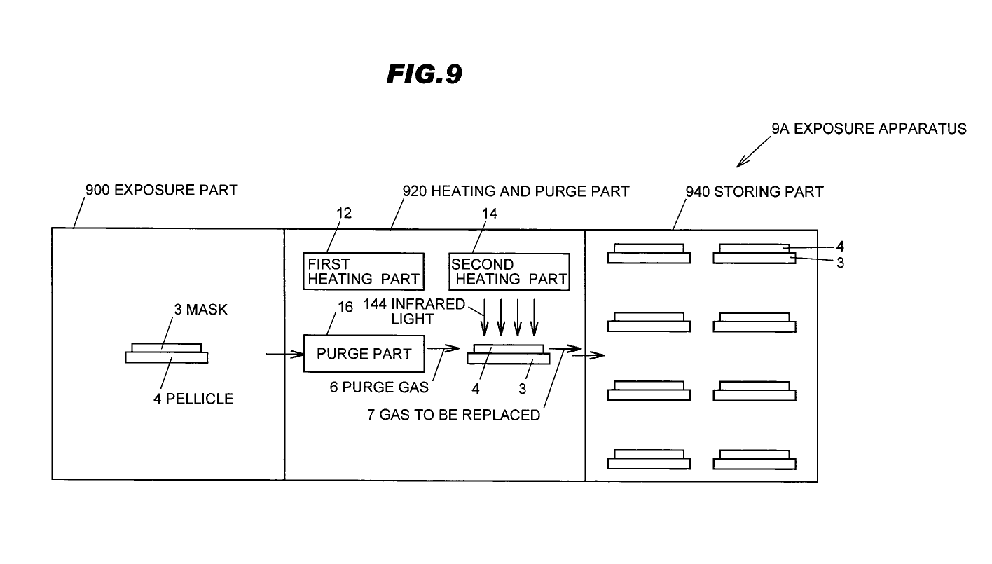

FIG. 9 is an explanatory view schematically showing an exposure apparatus according to a third embodiment. As shown in FIG. 9, the exposure apparatus 9A is roughly configured to include an exposure part 900, a heating and purge part 920 and a storing part 940.

The exposure part 900 is configured to carry out an exposure treatment by using the mask 3 with pellicle 4.

The heating and purge part 920 is configured to carry out the cleaning treatment, and is roughly configured, for example, to mainly include the first and second heating parts 12, 14 and the purge part 16 that have the same composition as the first embodiment. As the irradiation of the energy radiation, both of the irradiation to the whole of the mask film 32 and the irradiation with scanning can be adopted.

The storing part 940 is configured, for example, to store the mask 3 with pellicle 4 in which the cleaning treatment is completed. The exposure part 900, the heating and purge part 920 and the storing part 940 are configured, for example, to have a composition that when the mask 3 with pellicle 4 is moved between the exposure part 900, the heating and purge part 920 and the storing part 940, it does not come into contact with external air.

Hereinafter, an action of the mask cleaning apparatus 1 according to the third embodiment will be explained.

### (Action of Third Embodiment)

First, the mask 3 with pellicle 4 that is used in a predetermined frequency is moved to the heating and purge part 920 by the exposure part 900. At the time of the movement, the mask 3 with pellicle 4 is not exposed to external air.

Next, the mask film 32 of the mask 3 with pellicle 4 moved to the heating and purge part 920 is irradiated with the ultraviolet light 124 from the first heating part 12 and simultaneously the purge gas 6 is sent out from the purge part 16 into the interior space 400 via the inlets 48 of the pellicle 4. As the purge gas 6, air including oxygen having a low degree of humidity is used. The ultraviolet light 124 has the same wavelength as the ultraviolet light used in the first embodiment.

Next, the mask film 32 of the mask 3 with pellicle 4 is irradiated with the infrared light 144 from the second heating part 14 and simultaneously the purge gas 6 is sent out from the purge part 16 into the interior space 400 via the inlets 48 of the pellicle 4. As the purge gas 6, CDA or nitrogen is used. The infrared light 144 has the same wavelength as the infrared light used in the first embodiment.

Next, after atmosphere in the interior space 400 is entirely replaced with the purge gas 6, the mask 3 with pellicle 4 is moved to the storing part 940 and the cleaning treatment is completed. At the time of the movement, the mask 3 with pellicle 4 is not exposed to external air.

In addition, in the exposure apparatus 9A, when the mask 3 with pellicle 4 is moved from the storing part 940 to the exposure part 900, the mask 3 with pellicle 4 is not exposed to external air.

### Fourth Embodiment

Hereinafter, a method of a semiconductor device by using the mask 3 with pellicle 4 to which the cleaning treatment is applied by the above-mentioned mask cleaning apparatus, mask cleaning system, or exposure apparatus will be explained.

### (Manufacturing of Semiconductor Device)

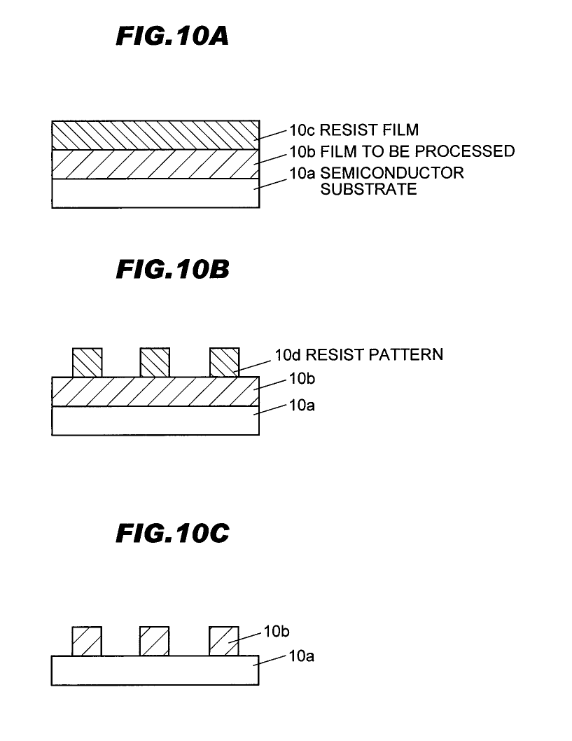

FIGS. 10A to 10C are cross-sectional views schematically showing the primary portions of a method of manufacturing a semiconductor device according to the third embodiment.

First, the mask 3 with pellicle 4 in which the cleaning treatment is completed is prepared.

Next, as shown in FIG. 10A, a film to be processed 10b is formed on a semiconductor substrate 10a by a chemical vapor deposition (CVD) method or the like, and a resist film 10c is formed on the film to be processed 10b formed by a spin coat method or the like.

The semiconductor substrate 10a is, for example, a Si based substrate including Si as a main component.

The film to be processed 10b can be, for example, a single film or a stacked film obtained by that a large number of films are stacked.

Next, as shown in FIG. 10B, a pattern of the mask 3 with pellicle 4 is formed in the resist film 10c as latent image by a photolithography method using the mask 3 with pellicle 4 in which the cleaning treatment is completed, and a resist pattern 10d is formed by carrying out an development treatment, a rinse treatment and the like.

Next, as shown in FIG. 10C, the film to be processed 10b is etched by using the resist pattern 10d as a mask based on a reactive ion etching (RIE) method, and the resist pattern 10d is removed. Subsequently, via well-known steps, a desired semiconductor device is obtained.

According to each of the above-mentioned embodiments, the cleaning treatment of the mask can be carried out, while generation of the outgas in accordance with heating is prevented.

While certain embodiments have been described, these embodiments have been presented by way of example only, and not intended to limit the scope of inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of cleaning a mask, comprising:
irradiating a mask film having a mask pattern on a substrate with an energy radiation and heightening a temperature of the mask film than that of the substrate.

2. The method of cleaning a mask according to claim 1, wherein the mask film is surrounded by a pellicle configured to include a pellicle frame and a pellicle film bonded to an upper surface of the pellicle frame.

3. The method of cleaning a mask according to claim 2, wherein the pellicle is fixed to the substrate by a material including silicone.

4. The method of cleaning a mask according to claim 1, wherein the irradiating the mask film with the energy radiation is carried out by that the mask film is irradiated with ultraviolet light as the energy radiation and then the mask film is irradiated with infrared light as the energy radiation.

5. The method of cleaning a mask according to claim 2, wherein the pellicle frame has an inlet and an outlet, and after the energy radiation is irradiated, a purge gas is introduced from the inlet into the pellicle and a gas to be replaced in the pellicle is replaced with the purge gas, and the gas to be replaced that is replaced is discharged from the outlet formed in a side surface of the pellicle.

6. The method of cleaning a mask according to claim 5, wherein a filter is disposed in at least one of the inlet and outlet.

7. The method of cleaning a mask according to claim 1, wherein the irradiation of the energy radiation is carried out via a light collecting part configured to collect the energy radiation.

8. The method of cleaning a mask according to claim 1, wherein the mask is stored without being exposed in the external air, after the mask film is cleaned.

9. The method of cleaning a mask according to claim 3, wherein the mask is stored without being exposed in the external air, after the mask film is cleaned.

10. The method of cleaning a mask according to claim 1, wherein the irradiation of the energy radiation is carried out and holding the temperature of the substrate at 70 or less degrees.

11. The method of cleaning a mask according to claim 2, wherein the pellicle frame comprise an aluminum alloy or a synthetic resin.

12. The method of cleaning a mask according to claim 2, wherein the pellicle film comprise a fluorine based organic compound.

13. The method of cleaning a mask according to claim 5, wherein the purge gas comprise a clean dry air (CDA) or nitrogen.

14. The method of cleaning a mask according to claim 5, wherein a degree of humidity of the purge gas is not more than 10%.

15. The method of cleaning a mask according to claim 1, wherein the mask film comprise a half tone film.

16. A mask cleaning apparatus, comprising:
a heating part configured to irradiate a mask film having a mask pattern formed on a substrate of a mask with an energy radiation so as to selectively heat the mask film.

17. The mask cleaning apparatus according to claim 16, wherein the heating part includes a first heating part configured to irradiate the mask film with ultraviolet light, and a second heating part configured to irradiate the mask film with infrared light.

18. The mask cleaning apparatus according to claim 16, wherein a storing part configured to store the mask after energy radiation is irradiated is further included.
